(19) United States
(12) Patent Application Publication
(10) Pub. No.: US 2004/0006908 A1
(43) Pub. Date: Jan. 15, 2004

(54) Shape-retaining baits and leaders

(76) Inventors: Larry Essad, Lake Hubert, MN (US); Eugene Champeau, Medina, MN (US)

Correspondence Address: INTELLECTUAL PROPERTY GROUP, FREDRIKSON & BYRON, P.A., 4000 PILLSBURY CENTER, 200 SOUTH SIXTH STREET, MINNEAPOLIS, MN, 55402, US

(21) Appl. No.: 10/194,415

(22) Filed: Jul. 12, 2002

(51) Int. Cl. A01K 85/00

(52) U.S. Cl. 43/42.13

(57) ABSTRACT

An improved fishing lure used for bait casting including artificial baits and leaders. The fishing lure comprises a wire body that may be formed of a superelastic alloy comprising not greater than about 20 percent of nickel and about 30 percent of chromium, with the remainder being titanium. The wire body may have a bight and engaging divergent legs which extend from the bight. Preferably, the bight is in a generally R-shaped configuration. In one embodiment, the invention provides a fishing lure having a shape memory alloy wire body having contacting, generally flat wire surfaces to provide more rigidity to the lure, thus improving lure performance.

### FIELD OF THE INVENTION

The present invention relates to improvements in fishing gear, particularly fishing lures used for bait casting including artificial baits and leaders. More particularly, this invention in one embodiment provides a fishing lure made from wire having superior shape memory, flexibility and tensile strength characteristics. In another embodiment, the invention provides a fishing lure having a shape memory alloy wire body having contacting generally flat wire surfaces to provide more rigidity to the lure, thus improving lure performance.

### BACKGROUND OF THE INVENTION

Fishing is one of the most popular outdoor sports in the world and is a sport that can be enjoyed by persons of all ages. In sport fishing, many different types of fishing lures are designed to simulate fish food in order to make the lure attractive to fish. These artificial baits generally include a body having one or more fish hooks mounted to one end of the body and a loop mounted to the other end of the body so that fishing line can be attached to the bait. The bodies of bait are commonly made of wire to enhance the strength of the bait, thus reducing breakage. The design or pattern of the bait used depends on the type of fish the bait will hopefully attract. For example, large baits used for teeth-bearing fish such as muskellunge may include a strong wire body having a wire loop at one end for attachment to either a fishing line or wire leader, one or more hooks at its other end, and a series of spinners, propellers, skirts, spoons, beads, rattlers, hair-like fibers, bristles and other fish-attracting elements carried along the length of the wire body to simulate a small fish.

Spinner baits are a popular type of artificial bait and utilize a spinner to attract fish by producing sound, vibrations and glimmer as the lure is being pulled through the water. The spinner bait body generally comprises a length of wire bent at its center to form two diverging legs that are vertically aligned and angled with respect to one another. The bend is in the form of a loop or bight for attachment to a fishing line or leader. To the end of one of the diverging legs may be mounted a spinner or other fish-attracting element, while to the end of the other diverging leg may be mounted a weighted-body shaped like a minnow which is attached to a hook. The hook can be singular or shaped like an anchor and commonly has a shank that is parallel to the other leg. Spinner baits are further described in U.S. Pat. No. 5,605,004 (Boullt et al.), U.S. Pat. No. 4,823,500 (Shindeldecker), U.S. Pat. No. 5,412,899 (Reboul), U.S. Pat. No. 5,647,163 (Gorney), U.S. Pat. No. 3,808,726 (Flanigan, Jr.), U.S. Pat. No. 4,619,068 (Wotawa), and U.S. Pat. No. 4,625,448 (Borders).

As stated above, spinner baits can either be connected to the fishing line itself, or to a wire leader which is connected to the fishing line, depending on the type of species of fish the angler hopes to catch. For example, spinner baits designed for bass fishing commonly have the body wire bent into an open, generally U-shaped bight to which a braided or monofilament fishing line can easily be tied. The open nature of the bight helps to avoid fishing line tangles since the line, when pulled taut, can untangle by passing through the bight. Alternatively, spinner baits designed for northern pike commonly have the body wire bent into a closed loop and utilize a wire leader for attaching the bait to the fishing line for strengthening purposes. The bight is closed to prevent the leader from sliding along the legs of the spinner bait's body. The wire leader typically comprises a core metal wire (or wires bundled together) with loops at both ends. One end is secured to an interlock snap fastener for attachment to the fishing line while the other end is secured to an interlock snap swivel fastener for attachment to the spinner bait. The interlock snap swivel fastener allows baits to be easily interchanged as well as permitting the spinner bait to rotate without rotating the fishing line.

Commercially available spinner baits and leaders are commonly made of stainless steel wire but can also include carbon steel, plastic or the like. Stainless steel wire has the ability to resist rusting, is readily available, economical, strong and can be easily bent to form the wire frame of a spinner bait body or leader. However, the stainless steel wire can become bent, kinked, or spiraled during use if it is struck by large fish or if excessive force is applied to the fishing line when removing a spinner bait or leader caught in underwater obstructions such as rocks, weeds or logs. Although the stainless steel wire frame may be repaired, the necessity of re-bending a leader into its initial true straight configuration or of re-bending a bait body to obtain something near the true desired shape of the original bait presents obvious difficulties including fatigue deformation and mechanical failure of the wire.

A core wire, cylindrical in cross-section, comprising a nickel-titanium alloy in a ratio of about 55% nickel and about 45% titanium has recently been reported in the manufacture of spinner baits and leaders to reduce wire deformation and enhance the flexibility of the wire (see U.S. Pat. No. 6,266,914 B1 (Johnson et al.), U.S. Pat. No. 5,875,585 and U.S. Pat. No. 5,711,105 (Schreifels et al.) and U.S. Statutory Invention Registration H1,865 (Aoki)). When spinner baits are made from this nickel-titanium alloy, the wire frame, if bent, will return to its original orientation, thus allowing the bait to be used over and over again without having to manually straighten the bait once it becomes deformed. The problem with using a nickel-titanium alloy as described above for spinner baits however is that the nickel-titanium wire is too flexible. When an angler pulls on a cast fishing line, a force is generated that causes the spinner bait's legs to contract towards each other. If the legs collapse too far, a fish can spit out the hook before the hook will set. In addition, legs that converge or vibrate too much reduces a fishing lure's attractiveness to fish, thereby reducing the chances of capturing the fish. In order to keep the legs from collapsing on each other too much as the spinner bait is being pulled through the water, the nickel-titanium wire has to be sufficiently rigid. Wire rigidity can be increased by increasing its diameter; however, this causes the resulting bait to become overly heavy and bulky. Spinner bait rigidity can also be improved by bending the wire into a loop-like structure where portions of the wire legs at the loop opening may come into contact with each other. However, slippage may occur between the contacting portions of the legs and this reduces rigidity and again leads to poor fishing results. Therefore, it would be desirable to provide a light gauge wire that can be used for making fishing lures, such as spinner baits and leaders, that has shape memory characteristics, is flexible, has high tensile strength and is additionally sufficiently rigid to provide good fishing results.

### SUMMARY OF THE INVENTION

The present invention provides a fishing lure having an elongated, flexible, shape-retaining wire body. The wire body is formed to a predetermined configuration and comprises a shape memory superelastic alloy having a transition temperature below about 10° C. to enable the wire body to elastically regain its predetermined configuration after being deformed. Shape memory superelastic metal alloys are those alloys that can be deformed to a far greater degree than can other metals and metal alloys without taking a permanent set. Various alloys possess different superelastic characteristics. Of these, an alloy of nickel, chromium, and titanium wire may be used in the present invention to create a lure having improved performance, the alloy comprising weight percentages of not greater than twenty (20) percent nickel, about thirty (30) percent chromium and the remainder titanium, and providing increased stiffness. This alloy is referred to below, for brevity, as a “20-30” alloy.

The fishing lure may comprise a bait having a fish hook operatively carried at a first end of the wire body and one or more fish attracting elements attached to the wire body between the fish hook and the second end of the wire body. The first and second ends may have loops or other attachment means so that the wire body may be secured to fishing line. Alternatively, the lure may be secured to a fishing leader, the leader then being attached to fishing line. The leader may comprise a length of straight or braided wire of the 20-30 alloy described above to form a core body. The core body may have at one end a loop fastener for attaching to fishing line and at its other end an interlock snap fastener for securing the fishing lure.

In a preferred embodiment, the fishing lure made from the 20-30 alloy may be initially formed to have a configuration of the type used for muskellunge or other large fish where the wire body is substantially straight. In a more preferred embodiment, the lure made from this alloy may be initially formed in a spinner-bait type configuration. The spinner-bait configuration is formed with the superelastic 20-30 alloy wire body having a center portion permanently bent back upon itself to form two legs and an attachment loop for securing fishing line or leader to the spinner bait. The attachment loop is formed by bending the wire body through an angle greater than 180° to form a bight. Preferably, the bight is generally R-shaped. The two legs diverging from the attachment loop are in substantial engagement with each other adjacent the bend before they separate. The substantial engagement of the legs provides rigidity to the lure by transmitting force, generated when the lure is pulled through the water, from one leg to the other. This reduces elastic movement of the attachment loop itself and additionally reduces the time that movement of the legs, and therefore the fish hook, lags movement of the attachment loop when the angler pulls on the fishing line in order to set the hook.

A further object of the present invention is to provide a spinner bait configuration described above that is formed from any superelastic alloy wire (but preferably the 20-30 alloy) having generally flat confronting surfaces where the legs substantially engage each other adjacent the bight. The wire body can be formed of a nickel-titanium superelastic alloy, the nickel-titanium alloy being, e.g. nitinol, but preferably is formed of a nickel-chromium-titanium alloy of the type described above. The flat confronting surfaces provide further rigidity to the lure than surfaces formed by round wire and restrain the legs at the substantial engagement portion from sliding past each other. Additionally, the wire employing a flat surface may allow for a more desired vibration generated by the lure as it is being used so as to enhance the lure's attraction to fish. The wire body preferably has a rectangular cross section with the longer dimension of the rectangular wire preferably being parallel to the plane that the lure flexes in during use to allow for optimal lure rigidity.

### BRIEF DESCRIPTION OF THE DRAWINGS

FIG. 1 is a representation of a fishing lure of the invention, with some fiber elements being removed for clarity;

FIG. 2 is a representation of a stress/strain curve for the shape memory superelastic alloy of the invention;

FIG. 3 is a representation of a spinner bait of the invention;

FIG. 3A is a broken away view of a portion of the bait of FIG. 3, showing a generally R-shaped bight;

FIG. 3B is a cross-sectional view taken along line 3B-3B of FIG. 3A;

FIG. 4 is a schematic representation of a wire portion of the lure of FIG. 3;

FIG. 5 is a representation of testing apparatus for measuring stiffness of the wire of FIG. 4;

FIG. 6 is a broken away view of a leader of the invention;

FIG. 6A is a broken away view of FIG. 6 showing an attachment loop;

FIG. 6B is a broken away view of FIG. 6 showing a different snap fastener;

FIG. 6C is a broke away view of FIG. 6 showing a different attachment loop

FIG. 7 is a broken away view of another leader of the invention utilizing a braided configuration; and

FIG. 7A is a broken away view similar to the left hand portion of FIG. 5 but showing a modified embodiment.

### DETAILED DESCRIPTION OF THE PREFERRED EMBODIMENTS

The following detailed description is to be read with reference to the drawings, in which like elements in different drawings have been given like reference numerals. The drawings, which are not necessarily to scale, depict selected embodiments and are not intended to limit the scope of the invention. Examples of constructions, materials, dimensions, and manufacturing processes are provided for selected elements. All other elements employ that which is known to those of skill in the art of the invention. Skilled artisans will recognize that the examples provided herein have many suitable alternatives that can be utilized, and which fall within the scope of the invention.

Of importance to the present invention are shape memory alloys and in particular their shape memory and superelastic properties. Shape memory alloys are a group of metallic materials having the ability to return to their original shape upon heating via a phase change transformation. These metallic materials typically include an alloy of nickel and titanium at a ratio of about 50 atomic percent of each (about 55 percent by weight of nickel), the most well-known nickel-titanium material being called nitinol, but can also consist of a copper base alloy such as CuAlNi or CuZnAl. The nickel-titanium alloy is the form generally used commercially since it has a greater shape memory strain, is more thermally stable, has excellent corrosion resistance, and is biocompatible. The 20-30 alloy referred to above is a particularly preferred superelastic alloy.

Shape memory alloys can exist in either of two crystallographic forms; austenite and martensite. Austenite is the stronger parent phase, is characterized by a body centered cubic structure, and typically exists at higher temperatures. In comparison, martensite is the more deformable phase, is characterized by a monoclinic structure, and typically exists at lower temperatures. Which form the alloy will be in depends on several variables including ambient temperature, chemical composition, and the thermomechanical history of the alloy.

In general, a shape memory alloy works by undergoing a phase transformation when it is cooled from its high temperature austenite form to its lower temperature martensite form. The phase transformation does not occur at a single temperature, but over a range of temperatures that varies for each alloy. In general, the alloy will be in an austenite form at a temperature above Af, a phase transformation temperature at which the alloy will completely change into its austenite form. As the alloy is cooled, the austenite form will begin to transform to a martensite form at a temperature Mₛ. As the alloy is further cooled, it completes its phase transformation into a pure martensite form at a temperature M_{f}. The temperature range between Mₛ and M_{f} is typically narrow. When the alloy reaches its martensite form, it can be easily deformed to a new shape and will continue to remain in this deformed state until heated. Once heat is applied, the alloy will pass back through its phase transformation temperatures and revert back to its austenite form whereby it will recover its original shape. Therefore, fishing lures made from shape memory alloy can take advantage of this shape memory property by applying heat to a deformed lure to make the lure return to its original configuration.

In addition, shape memory alloys also exhibit superelastic properties when the alloy is deformed isothermally at a temperature just slightly above the phase transformation temperature A_{f}. Generally, superelasticity occurs when an external physical stress is applied to an area of the alloy at a temperature slightly above the temperature A_{f}. As an external force is being applied to the alloy, it causes that portion of the alloy to be transformed from an austenite form to a martensite form, thereby forcing the alloy to become deformed. As long as the force is maintained, the alloy will remain in the martensite form and continue to maintain its deformed position. Once the physical stress is released, the deformed portion of the alloy will spring back to its original shape and in so doing will return to the austenite form without the need for heating. A fishing lure made from shape memory alloy can take advantage of superelasticity by designing the lure from an alloy having an A_{f} temperature just slightly below the water temperature in which the lure will be used. Thus, if the lure becomes deformed during use by an external physical force, it can be returned to its original configuration by simply removing the force, without the need for applying heat.

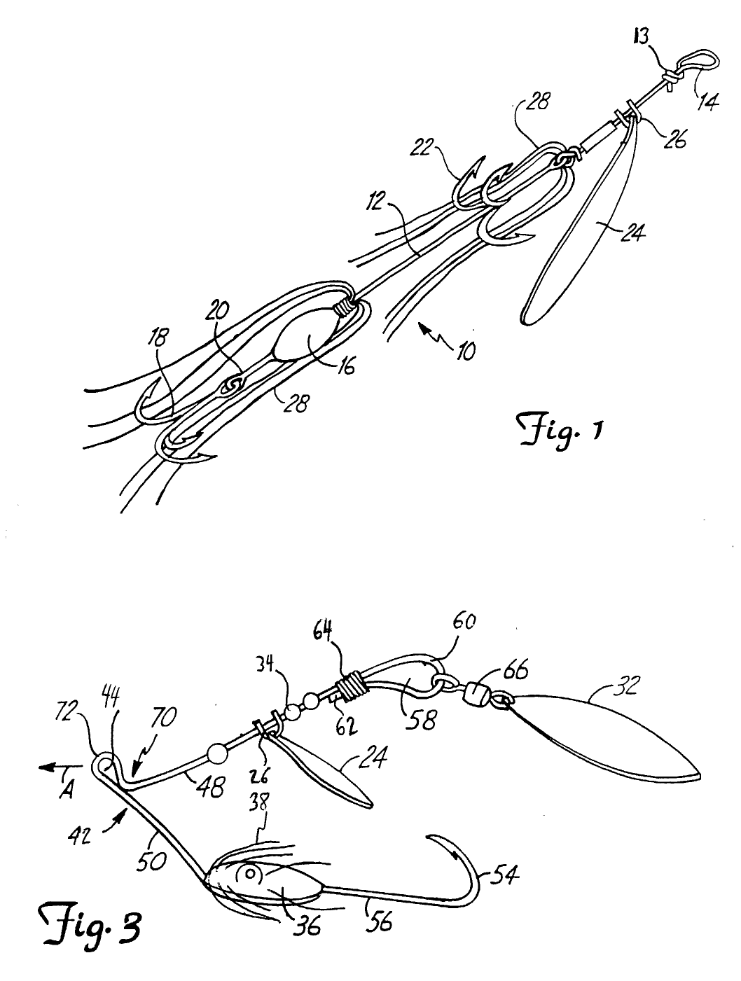

Referring now to the drawings, and in particular FIG. 1, there is shown a typical fishing lure. More specifically, FIG. 1 illustrates the basic configuration of a fishing lure of the type typically used for fishing larger fish such as those of the pike family, e.g. muskellunge, but is not intended to be representative of all of the features commonly found in a fishing lure. FIG. 1 shows a fishing lure 10 that is mainly composed of an elongated wire body 12, several fish attracting elements and a fish hook. The elongated wire body 12 is formed of an alloy exhibiting shape memory and superelastic properties at a specific temperature range reflecting temperatures of water in which lure 10 is to be used. The alloy comprises nickel, chromium and titanium with weight percentages ranging from not greater than about twenty (20) percent nickel, about thirty (30) percent chromium and the remainder titanium, and is referred to, as noted above, as a “20-30” alloy.

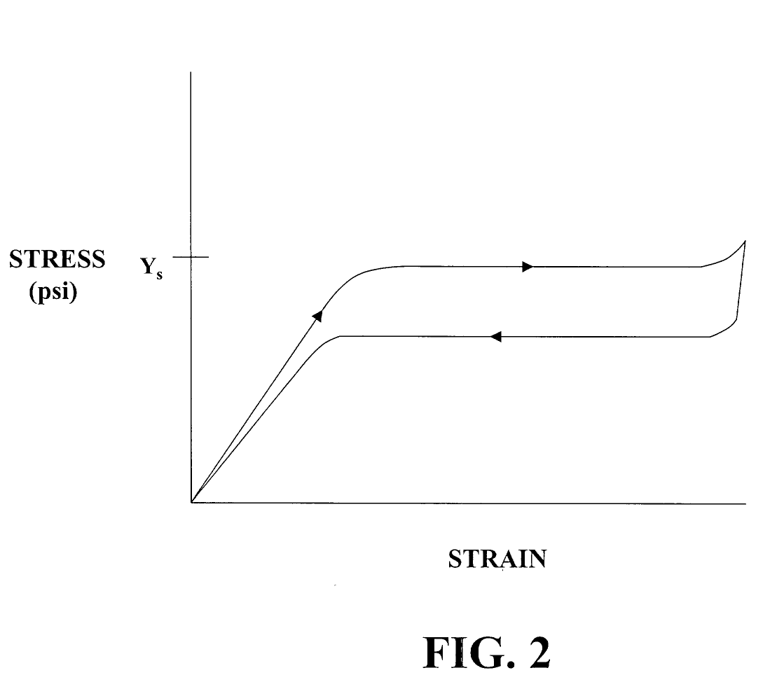

The new 20-30 alloy has superelastic properties of the type shown in FIG. 2. As an external stress is applied to the new alloy, it will undergo linear strain until a certain yield stress, Yₛ, is reached. The alloy will then exhibit an increasing strain at a nearly constant or slightly increasing stress thereby forming stress-induced martensite. Once the stress is released, the alloy will revert back to its austenite form and therefore to its original shape. The new alloy is formed so that it has superelasticity at the temperature of use (which could range down to 10° C. and often down to near 0° C., the freezing point of water). The new alloy is also much stiffer than other shape memory superelastic alloys, including nitinol, providing at least fifteen (15) percent more stiffness than other shape memory superelastic alloys, where stiffness indicates a wire's resistance to deformation.

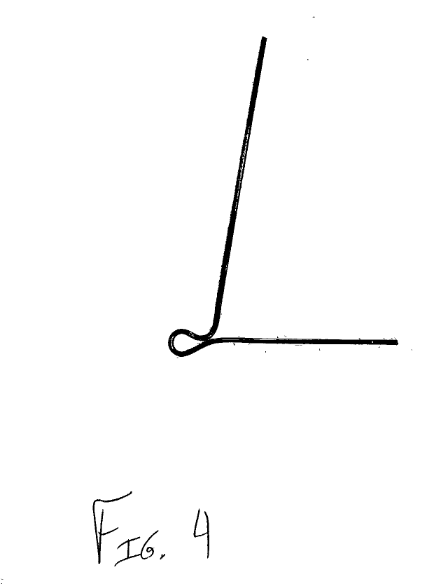

The “20-30” alloy referred to above is substantially stiffer than superelastic alloys made from approximately 50% (atomic) of titanium and nickel. FIG. 5 schematically depicts a stiffness testing device in which the load (in ounces) is recorded for each given amount of bending. Here, the wire depicted in FIG. 4 is clamped by clamp 37 where indicated, and force tending to bend the wire in the direction of the arrow is applied to the wire. The results are given in the following table, in ounces of force for each five degrees of bend.

| | | | | | Rectangular 20-30 | |
|---|---|---|---|---|---|---|
| Degrees | Round Nitinol | | Round 20-30 | | 0.0256 × | 0.0253 × |
| of Bend | 0.0386″ | 0.0387″ | 0.0386 | 0.0386 | 0.0361 | 0.0363 |
| 5 | 0.25 | 0.25 | 1.0 | 0.75 | 0.50 | 0.50 |
| 10 | 0.5 | 0.5 | 2.2 | 1.9 | 1.7 | 1.3 |
| 15 | 1.2 | 1.15 | 2.75 | 3.25 | 2.5 | 2.25 |
| 20 | 1.3 | 1.5 | 3.99 | 4 | 3.4 | 4.25 |
| 25 | 1.9 | 2 | 4.51 | 5.25 | 4.25 | 5.25 |
| 30 | 2.45 | 2.51 | 5.75 | 5.8 | 5.45 | 6 |
| 35 | 2.5 | 2.9 | 6.45 | 6.75 | 7 | 7.25 |
| 40 | 3 | 3.7 | 6.75 | 7.45 | 8.5 | 7.75 |
| 45 | 3 | 3.8 | 7.3 | 8.1 | 9.9 | 8.75 |

Referring back to FIG. 1, at one end of the wire body 12 is a first closed end loop 14 for attachment to a fishing line or leader. Closed end loop 14 can be formed by doubling back wire body 12 upon itself toward the other end. A spring cover 13 can be used to ensure that loop 14 remains closed. Alternatively, closed end loop 14 can be formed using a flat wire weld. Adjacent to closed end loop 14 is mounted a blade 24 which typically comprises a leaf-shaped or oval shaped thin metal plate, being highly reflective and having a curved mid surface to cause the blade to rotate as the lure is being pulled through the water. The blade 24 is formed with an aperture so that it can be directly mounted on the wire body 12, or as is shown in FIG. 1, can be mounted to the wire body through the use of a clevis 26 in known fashion. Adjacent to blade 24 may be mounted a treble hook 22 of known design having bundles of hair fibers 28 extending down over the hook to enhance the attraction of the lure to fish, the hair fibers being described below.

On the other end of wire body 12 is a second closed end loop 20 for attachment of wire body 12 to fish hook 18. Fish hook 18 is pivotally fastened to closed end loop 20 and typically comprises a treble hook of known design but may include other hooks of known design. Adjacent to fishhook 18 is a molded-on minnow shaped body 16. The minnow shaped body 16 is formed to imitate bait so that fishing lure attractiveness is increased and can additionally act as a weight to prevent fishing lure 10 from rising. Bundles of hair fibers 28 can be employed in a known fashion in this bait, the bundles of fibers commonly being attached to the wire body 12 just above the minnow shaped body 16 and just below blade 24, the fibers tending to stream rearwardly as shown. In FIG. 1, only a few fibers are shown for clarity purposes. The hair fibers 28 typically include thin plastic or rubber elements intended to attract fish to wire body 12. Hair fibers 28 are generally removable so that the fibers can be easily replaced if they become damaged or if the angler desires a new appearance for fishing lure 10.

During use, fishing lure 10 acts similarly to other fishing lures made from non-shape memory alloy materials. When a fishing line, attached to fishing lure 10 is pulled, fishing lure 10 will move in the direction of the angler and in such a way so as to attract fish. If fishing lure 10 is caught in an obstruction (e.g. aquatic plant or rock) or struck by a fish while the fishing line is being pulled, wire body 12 will become bent or deformed. However, once fishing lure 10 is removed from the obstruction, wire body 12 will immediately return to its original shape due to its superelasticity. Therefore, fishing lure 10 does not have to be re-bent or reshaped before it is used again.

If the wire body 12 is made of nitinol or other relatively non-stiff superelastic material, in order to provide the required stiffness, large wire diameters were required, making the lure relatively heavy. By forming the wire body 12 of the lure of FIG. 1 from a stiffer alloy, particularly the 20-30 alloy, smaller diameter wires can be employed. This advantage extends to the other lure shapes described herein, of course.

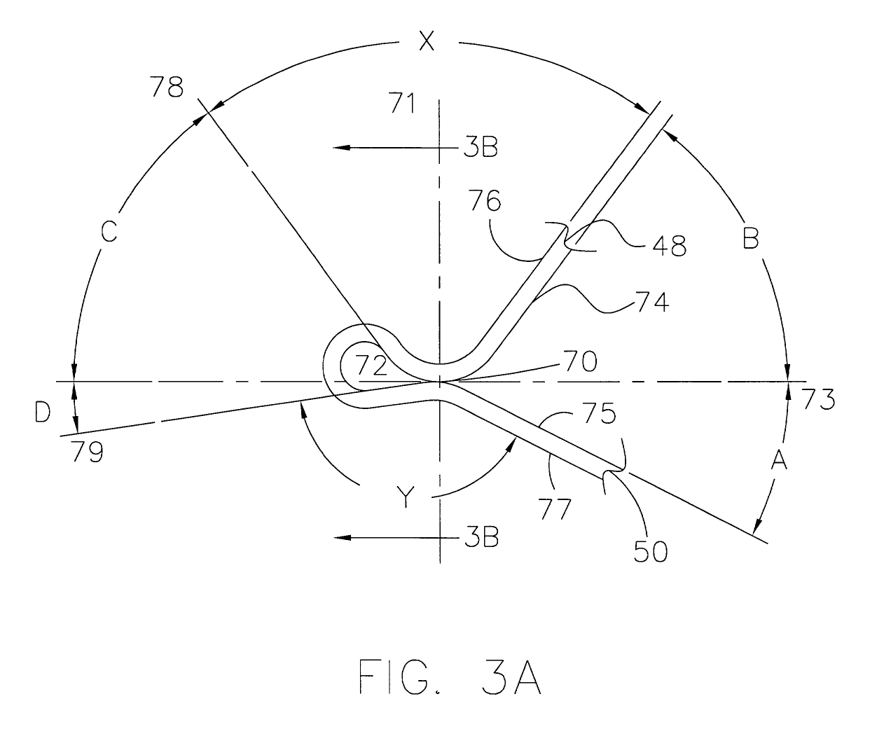

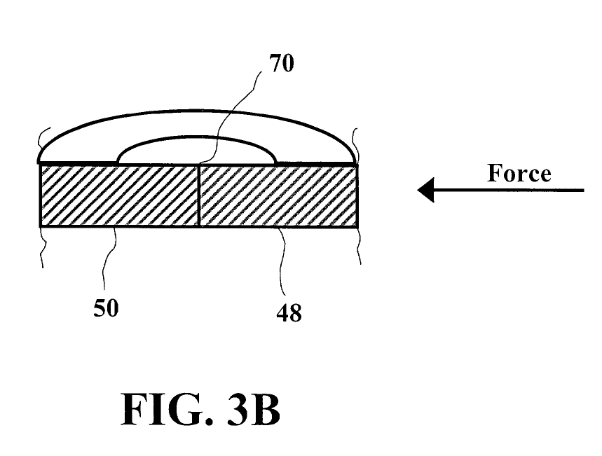

Shown in FIG. 3 is a spinner bait that is another embodiment of the present invention. The spinner bait is composed of several fish attracting elements including: a spoon 24, a spinner 32, beads 34, a minnow-shaped weighted body 36 and thin plastic or rubber strands 38 attached to the body 36 by means of a band 40. A variety of different elements of this general type can be placed on the bait to attract fish. The specific type of element that is employed depends mainly on the type of fish being pursued by the angler. Baits can use one or a plurality of these fish attracting elements.

Referring again to FIG. 3, the spinner bait 30 has a wire body 42 made of 20-30 alloy with stiffer superelastic properties as discussed above. Wire body 42 has a center portion 44 that forms bight 72. Bight 72 is produced by bending wire body 42 through an angle of greater than 180 degrees so as to divide wire body 42 into two (2) diverging legs 48 and 50. The bend causes the legs to converge into substantial engagement with each other, as shown at engagement position 70, before the legs diverge outwardly to form a generally R-shaped bight. Because of its design, the R-shaped bight provides more stiffness and rigidity since the load distribution of the lure is mainly on the bottom diverging leg 50 as compared to conventional-shaped bights where the load distribution is on both diverging legs 48 and 50.

FIG. 3A depicts the R-shaped bight in further detail. Engagement position 70 is bisected by lines 71 and 73 to form angles A, B, C and D. Angles A and B are defined by first and second inner wire segments 74 and 75 of diverging legs 48 and 50 and bisecting line 73. Angles C and D are defined by the first and second inner wire segments 74 and 75 (shown by dotted lines 78 and 79) of bight 72 and bisecting line 73. The generally R-shaped bight is formed such that angle A is about 15 to 25 degrees, angle B is about 40 to 50 degrees, angle C is about 40 to 50 degrees and angle D is about 10 to 20 degrees. In addition, angle y, defined by a first radius of curvature formed by the first outer wire segment 77 of diverging leg 50 and line 79 is greater than angle x, angle x being defined by a second radius of curvature formed by the outer wire segment 76 of diverging leg 48 and line 78. Also of note, bisecting line 73 intersects bight 72 in such a way so as to make the upper area, defined from bisecting line 73 to the upper portion of bight 72 much larger than the lower area, defined from bisecting line 73 to the lower portion of bight 72. In comparison, if line 73 were to bisect an asymmetrical attachment loop, the upper and lower portions of the attachment loop would be substantially equal.

Referring back to FIG. 3, to the end of leg 50 of wire body 42 is attached a minnow shaped weighted body 36. Extending from body 36 is a barbed hook 54. The hook 54 is oriented in such a way so that its tip 55 is pointing back towards leg 48. In addition, tip 55 is normally parallel to leg 48 so as to enhance the chance of capturing a fish. Attached to body 36 via holder 40 are strands 38 composed mainly of either thin plastic or rubber filaments. Strands 38 partially cover hook 54 and along with body 36 are designed in such a way so as to attract fish. In addition, note that the shank 56 of hook 54 and the axis of leg 50 may be at a slight angle to each other.

To the end of leg 48 of wire body 42 is a closed loop 58 formed by doubling back wire body 42 upon itself and toward leg 50. The doubled back portion 60 of wire body 42 terminates in a straight segment 62. A spring cover 64, or a flat wire weld (not shown) ensures that loop 58 remains closed. Attached to loop 58 by means of a swivel 66 is spinner 32. Alternatively, but not shown in FIG. 3, spinner 32 can be directly attached to loop 58 by means of an aperture in spinner 32. Intermediate engagement position 70 and doubled back portion 60 of wire body 42 can be placed slideable beads 34, spoon 24 attached to wire body 42 by clevis 26, and other fish attracting elements that are desired. The bait may be attached to a fishing line 68 by simply tying the line onto bight 72 or by utilizing a leader, preferably of the type described below.

Engagement position 70 serves several purposes which makes using fishing lure 30 advantageous over other similar conventional designed fishing lures. First, the engagement position 70 will keep a wire leader enclosed in bight 72 and prevent it from sliding along diverging legs 48, 50 should a leader be used to attach lure 30 to fishing line. If a leader is not used, and the lure is tied directly to fishing line at bight 72, the fishing line can slip past engagement position 70 and into bight 72 when the line is pulled taut, thus preventing the fishing line from becoming entangled. Therefore, the spinner bait is readily available for attaching either leaders or simple tie-on fishing line to bight 72.

Engagement position 70 rigidifies the legs 48, 50 with respect to forces that tend to cause the legs to converge during use. For example, when the bait is pulled in the direction of arrow A in FIG. 3, force B causes the legs to converge towards each other. Engagement of the legs at position 70 tends to eliminate the bight 72 from resilient bending and provides a stiffening effect to legs 48, 50 thus preventing convergence. It is also contemplated that engagement position 70 allows for the wire body 42 to be of somewhat smaller diameter than is used with conventional lures, thus making the lure lighter and improving lure performance.

As shown in FIG. 3B in a further embodiment, a wire with generally flat confronting surfaces at the mouth of the loop or bight can be used in place of round wire. The wire shown in FIG. 3B has a generally rectangular shape but any shape having flat confronting faces can be used, such as wire that is triangular or “D” shaped in cross section. Engagement of the flat surfaces further rigidifies legs 48, 50 by preventing the legs from slipping past each other at engagement position 70. Also, the flat confronting surfaces may create a more desired vibration in legs 48, 50 as the lure is being used which enhances the lure's attractiveness to fish. In a preferred embodiment, the flat wire comprises rectangular wire with the width of two opposing sides (49 in FIG. 3B) being longer than the width of the other opposing sides 51, and with the less wide sides coming into contact, as shown. The lure is generally shaped so that its frame lies in a single plane. The wire with generally flat surfaces can be made of 20-30 alloy or, if desired, any other shape memory alloy, including nitinol.

During use, fishing lure 30 acts similarly to other spinner bait fishing lures made from non-shape memory alloy materials. When a fishing line, attached to fishing lure 30 is pulled, fishing lure 30 will move in the direction of the angler and in such a way so as cause spinner 32 to rotate and attract fish. If fishing lure 30 is caught in an obstruction (e.g. aquatic plant or rock) or struck by a fish while the fishing line is being pulled, the lure will become bent or deformed. However, once fishing lure 30 is removed from the obstruction, the deformed portion of lure 30 will immediately return to its original shape due to its superelasticity. Therefore, fishing lure 30 does not have to be re-bent or reshaped before it is used again.

The lures of this invention may be manufactured using standard lure fabricating techniques, except the wire body, being made of a shape memory superelastic alloy, which requires separate processing steps. The wire body itself, of the type shown in FIGS. 1, 3, 4 and 5 is formed and is held in place with the desired bends while being heated to a temperature in the neighborhood of about 400° C. to about 600° C. Upon cooling, the superelastic alloy keeps its shape, as shown in the drawings. The fish-attracting elements can be strung onto the wire body as desired. Weighted bodies 16, 36 can be formed of lead or other heavy metal and, together with a fish hook, can be simply molded to the wire body using common bait forming techniques. The superelastic wire body referred to above is preferably generally circular in cross section, but the cross section configuration may be varied to include a rectangular cross section or other flat cross sections to provide further rigidity and a more preferred vibration of the lure during use.

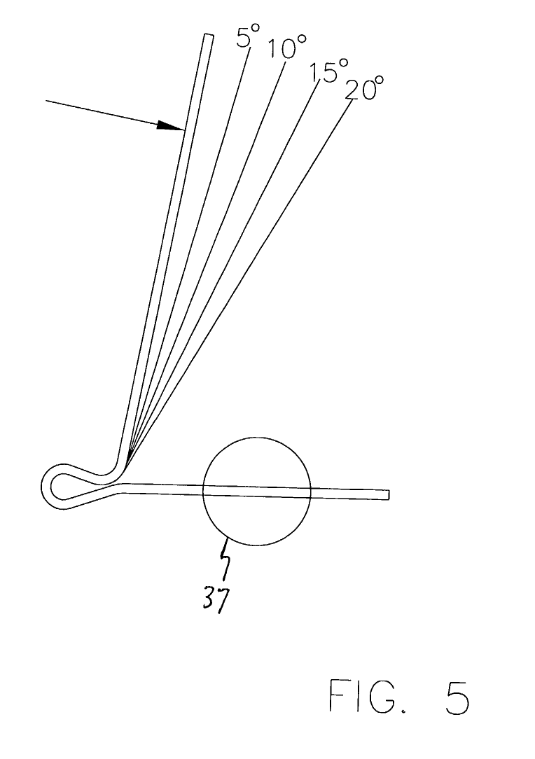

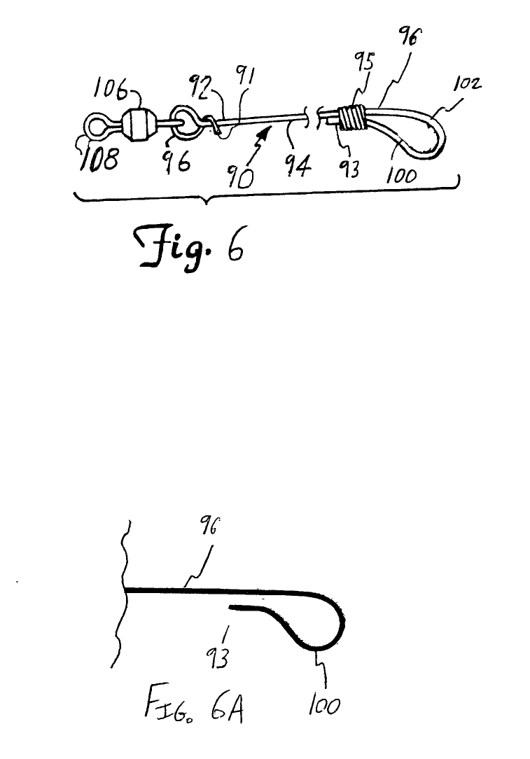

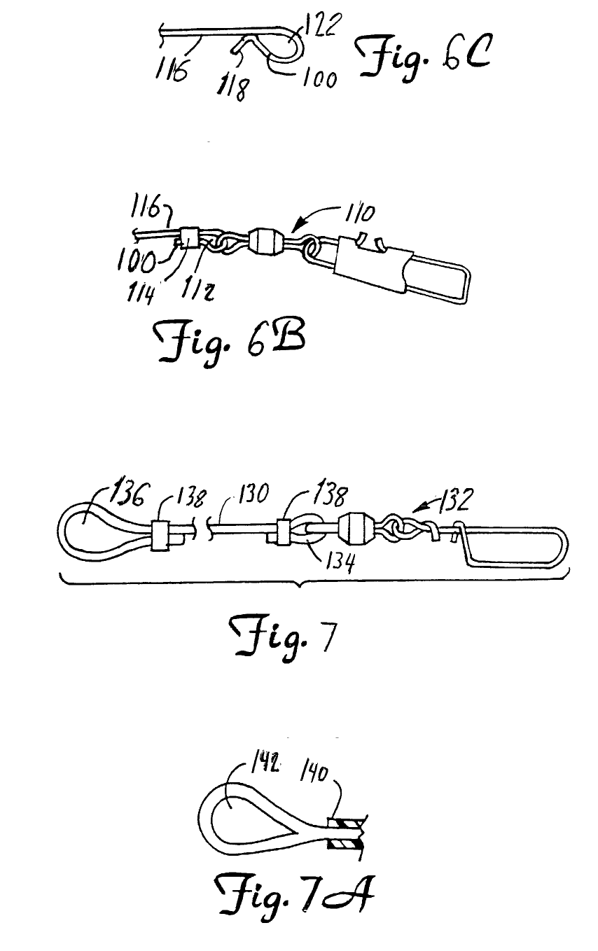

FIGS. 6-7A depict leaders that employ the 20-30 alloy in accordance with one embodiment of the invention. Referring to FIG. 6, a leader of the invention is shown at 90 and includes a wire body 92 having a central length 94 configured to lie in a straight plane. Because the leader of FIG. 6 is subjected substantially only to tensile forces, it may be of lesser diameter than the wire bodies shown in FIGS. 1, 3, 4 and 5. Attached at both ends of wire body 92 are attachment loops 96 and 102. Attachment loop 96 can be simply formed by twisting wire end 91 back toward wire body 92 to form a loop as is shown. A spring cover (not shown) can be placed over wire end 91 and wire body 92 to ensure attachment loop 96 remains closed. Attachment loop 102 can be formed by doubling back portion 100 to form loop 102 so that wire end 93 abuts wire body 92. A spring cover 95 can be placed over wire end 93 and wire body 92 so that loop 102 remains closed. When unlatched, the doubled back portion 100 may assume the configuration shown in FIG. 6A, permitting the attachment loop of a lure to be easily threaded onto the doubled back portion 100 of the leader and there captured in loop 102. Loop 96 can capture the end of a swivel 106 with loop 108 at the other end of swivel 106 being provided for attachment to a fishing line. Loop 96 may also be fashioned as a snap to enable attachment of the swivel 106.

As will be evident, a wide variety of interlock snaps, snap swivels, and the like may be used at the ends of the leaders of the present invention to attach fishing lines and lures. For example, in FIG. 6B, an interlock snap swivel 110 of known design is attached to a loop 112 formed by crimping the doubled back portion 100 of the leader wire to the adjacent straight portion 116 using a spring cover 114 of known design. In another embodiment shown in FIG. 6C, the end of the wire body is doubled back against the straight portion 116 of the wire, the bend direction then being reversed to form a short, outwardly extending end portion 118. Being made of the 20-30 alloy, the resulting loop 122 can readily receive the attachment loop of a bait over its doubled back portion 100. This specific embodiment is preferred for its ease of use.

The wire body of leaders of the present invention thus described may utilize a single wire filament of 20-30 alloy, as depicted in the drawing, or may be made of a bundle of such wire filaments to form a braided wire as shown in FIGS. 7 and 7A. Here, the individual wire fibers forming the wire braid may be much smaller in diameter than the single wire filaments shown in FIGS. 6-6C. In the leaders of FIGS. 7 and 7A, the wire body may be made from a tubular fabric of 20-30 alloy metal fibers. Two sets of essentially parallel, generally helical wire fibers may be employed, with the fibers of one set having a direction of rotation opposite that of the other, the resulting product being generally known in the fabric industry as a “tubular braid”. The length of tubular braid utilized to form the leader of FIGS. 7 and 7A is first formed by braiding in the usual manner, and then is stretched and retained taut in a straight orientation while undergoing the heat treatment referred to above. The resulting braid is quite flexible as it is bent, but has comparatively high axial tensile rigidity; that is, it exhibits very little, if any, stretch under tensile forces encountered in fishing.

After heat treatment while maintaining the tubular braid in tension, it may be fabricated as desired into a leader form. A segment of tubular braid is shown in FIG. 7 as 130. A commercially available interlock swivel snap 132 is attached to one end of the braided wire by doubling that end back upon itself and crimping it to the adjacent wire length as shown at 134 in FIG. 7. Similarly, the other end of the leader wire may be bent back upon itself to form an attachment loop 136, the end of the wire being attached to the adjacent wire length by a crimp 134. The attachment loops remain closed by spring cover 138. If desired, the end of the tubular braid may be doubled back upon itself as shown in FIG. 7A and may be rebraided into its adjacent length, as shown, in a manner similar to that used for making eyes in braided ropes for nautical use. As shown in FIG. 7A, a plastic coating 140 is formed along the length of the leader, but terminates short of the loop portion 142. If desired, the plastic coating can extend about the entire loop.

Thus, the present invention provides a fishing lure having the ability to avoid being permanently deformed when being struck by fish or when subjected to other physical forces of the type encountered in the sport of fishing.

While a preferred embodiment of the present invention has been described, it should be understood that various changes, adaptations and modifications may be made therein without departing from the spirit of the invention and the scope of the appended claims.

What is claimed is:

1. A shape retaining fishing lure comprising:
a. an elongated, flexible, shape-retaining wire body having a predetermined configuration and being formed of a superelastic alloy comprising not greater than 20 atomic percent of nickel, about 30 atomic percent of chromium, with the remainder being titanium, the alloy having superelastic properties and a transition temperature below about 10° C. to enable the wire body to elastically regain its predetermined configuration after being deformed;
b. a fish hook operatively attached to a first end of the wire body and at least one fish attracting element attached to the wire body between the fish hook and a second end of the wire body; and
c. attachment means carried by the wire body adapted for attaching the lure to a fishing line or leader.

2. The shape retaining fishing lure of claim 1 further comprising a leader including a core body having a straight length of the shape memory superelastic alloy, the body having attachment loops at each end of the core body so as to fasten the leader to the fishing line and the lure.

3. The shape retaining fishing lure of claim 1 wherein the wire body has a substantially straight predetermined configuration.

4. The shape retaining fishing lure of claim 1 wherein the wire body has a center portion permanently bent back upon itself to form two legs defining a bight, with the legs diverging therefrom, the bight having an upper portion and a lower portion and being formed by bending the wire body through an angle that exceeds 180°, the legs having contronting, substantially engaging surfaces at the mouth of the bight, the substantially engaging surface allowing generated forces upon the lure to be transmitted from one leg to the other through the substantially engaging surface rather than involving significant elastic movement of the loop.

5. The shape retaining fishing lure of claim 4 wherein said substantially engaging surfaces are planar to restrain such surfaces from slipping past each other as the wire body is flexed.

6. The shape retaining fishing lure of claim 4 wherein the center portion is bent such that the bight consists of a generally R-shaped loop.

7. The shape retaining fishing lure of claim 6 wherein each leg is bent away from the other at the mouth of the bight, the minimum radius of curvature of said bend of one leg being substantially greater than that of the other leg.

8. The shape retaining fishing lure of claim 5 wherein the minimum radius of curvature of said one leg is at least twice that of the other leg.

9. The shape retaining fishing lure of claim 5 wherein the wire body forming said engaging surfaces is generally rectangular in cross-section.

10. The shape retaining fishing lure of claim 5 wherein the wire body forming said engaging surfaces is generally triangular in cross-section.

11. The shape retaining fishing lure of claim 9 wherein said rectangular cross-section is defined by two pairs of parallel, opposing sides of unequal width, the sides of lesser width defining said engaging surfaces.

12. A shape retaining fishing lure comprising:
a. an elongated, flexible, shape retaining wire body, the wire body being formed of a shape memory superelastic alloy having a transition temperature below about 10° C. to enable the wire body to elastically regain a predetermined configuration after being deformed, the body having a substantially closed R-shaped bight adapted for attachment to a fishing line and formed by permanently bending the wire back upon itself through an angle that exceeds 180° to form first and second divergent legs extending from a top and a bottom end of the R-shaped bight;
b. a fish hook operatively attached to the first leg and at least one fish attracting element attached to the second leg; and
whereby downward force generated on the lure as it is pulled through the water is distributed on the bottom end of the R-shaped loop so that the loop remains substantially closed, said shape memory superelastic alloy comprises not greater than about twenty percent nickel, about thirty percent chromium and the remainder titanium.

13. The shape retaining fishing lure of claim 12 wherein the first divergent leg includes a first length and a second length, the second length extending at an angle of about 45° from the first length.

14. A shape retaining fishing lure comprising:
a. an elongated, flexible, shape retaining wire body, the wire body being formed of a shape memory superelastic alloy having a transition temperature below about 10° C. to enable the wire body to elastically regain a predetermined configuration after being deformed, the body having a substantially closed bight to which may be attached a fishing line and that is formed by permanently bending the wire back upon itself through an angle that exceeds 180° to form first and second divergent legs; the legs having substantially engaging flat confronting surfaces adjacent the bight;
b. a fish hook operatively attached to the first leg and at least one fish attracting element attached to the second leg; and
whereby the flat surfaces engage each other when the lure is pulled through the water to rigidify the lure, the flat surfaces restraining the legs from sliding past each other.

15. The shape retaining fishing lure of claim 14 wherein the shape memory superelastic alloy comprises not greater than about twenty percent nickel, about thirty percent chromium and the remainder titanium.

16. The shape retaining fishing lure of claim 14 wherein said wire is rectangular in cross-section.

17. The shape retaining fishing lure of claim 16 wherein the closed bight consists of a generally R-shaped loop.

18. The shape-retaining fishing lure of claim 16 wherein said wire, in cross-section, has two pairs of parallel, opposing sides defining said rectangular shape, the narrower of said sides defining said flat, confronting surfaces.

19. The shape-retaining fishing lure of claim 18 wherein said wire body, where bent to form said bight, lies in a plane, and wherein said confronting flat surfaces are perpendicular to said plane.
